(19) United States
(12) Patent Application Publication
(10) Pub. No.: US 2024/0430399 A1
(43) Pub. Date: Dec. 26, 2024

(54) VIDEO SEE-THROUGH TYPE VIDEO IMAGE DISPLAY APPARATUS

(71) Applicant: CANON KABUSHIKI KAISHA, Tokyo (JP)

(72) Inventor: YOICHI OSADA, Kanagawa (JP)

(21) Appl. No.: 18/747,921

(22) Filed: Jun. 19, 2024

(30) Foreign Application Priority Data
Jun. 20, 2023 (JP) 2023-100854

(51) Int. Cl. H04N 13/344; G06F 3/14

(52) U.S. Cl. CPC H04N 13/344; G06F 3/14

(57) ABSTRACT

A video image display apparatus includes a first imaging unit corresponding to a left eye of a user, a second imaging unit corresponding to a right eye of the user, a first display unit configured to display an image captured by the first imaging unit, a second display unit configured to display an image captured by the second imaging unit, and a control unit configured to control the first imaging unit and the second imaging unit, wherein the control unit is provided with an exposed area, and wherein the first imaging unit and the second imaging unit are in an independent state of not being constrained to each other in relation to the control unit, and at least portions thereof are exposed from the exposed area.

### BACKGROUND

### Technical Field

The present disclosure relates to a video see-through type video image display apparatus.

### Description of the Related Art

In recent years, a video image display apparatus that is mounted on the head of a user (an observer) and displays a video image in front of the eyes of the user has been used. Since the video image display apparatus is capable of displaying a video image on a large screen easily and providing stereoscopic vision easily, the video image display apparatus is used as an apparatus that enables the user to experience virtual reality (VR) or mixed reality (MR).

The video image display apparatus that realizes MR includes an imaging unit for capturing images of a subject corresponding to left and right eyes of a user, a display unit for displaying a three-dimensional (3D) computer graphics (CG) image created by a personal computer (PC) or the like superimposed on the images captured by the imaging unit, and observation optical systems for projecting the images to the user. Such a video image display apparatus is referred to as a video see-through type video image display apparatus.

A video image to be projected to the user is first displayed on display elements, such as small-size liquid crystal panels, corresponding to the left and right eyes of the user, and the video image is enlarged via the observation optical systems corresponding to the left and right eyes of the user. Then, the video image is projected to the left and right eyes of the user. The captured images of the subject are images having parallax corresponding to the left and right eyes. Further, parallax images corresponding to the left and right eyes of the user are generated from a 3DCG image and superimposed on the video image captured by the imaging unit. The images are displayed on the display unit via the observation optical systems. Accordingly, the virtual 3DCG image can be represented as if it existed in reality.

The video image display apparatus includes a control circuit board for controlling the imaging unit and the display unit. However, when the control circuit board is disposed above or below the imaging unit or the display unit, there is an issue that the video image display apparatus is increased in size. In order to reduce the size of the video see-through type video image display apparatus, it is considered to arrange the control circuit board so as to be aligned with the imaging unit and the display unit in a thickness direction of the apparatus. However, when the control circuit board is disposed between the imaging unit and the display unit, a space for the control circuit board is required between the imaging unit and the display unit. When the imaging unit and the display unit are separated due to the space, magnifications may be different between an image captured by the imaging unit and the reality, and the displayed image may be unnatural. For example, Japanese Patent Application Laid-Open No. 2005-323396 discusses an imaging apparatus in which an opening is provided in a control circuit board, an imaging unit is fixed to the control circuit board so as to close the opening, and the imaging unit and the control circuit board are electrically connected to each other.

### SUMMARY

According to an aspect of the present disclosure, a video image display apparatus includes a first imaging unit corresponding to a left eye of a user, a second imaging unit corresponding to a right eye of the user, a first display unit configured to display an image captured by the first imaging unit, a second display unit configured to display an image captured by the second imaging unit, and a control unit configured to control the first imaging unit and the second imaging unit, wherein the control unit is provided with an exposed area, and wherein the first imaging unit and the second imaging unit are in an independent state of not being constrained to each other in relation to the control unit, and at least portions thereof are exposed from the exposed area.

Further features of the present disclosure will become apparent from the following description of exemplary embodiments with reference to the attached drawings.

### BRIEF DESCRIPTION OF THE DRAWINGS

FIG. 1 is a perspective view illustrating a state in which a video image display apparatus according to one or more aspects of the present disclosure mounted on a head.

FIG. 2 is a perspective view of the video image display apparatus according to one or more aspects of the present disclosure as viewed from a rear side.

FIG. 3 is a cross-sectional view along a dashed line A-A in FIG. 1.

FIG. 4 is a front perspective view illustrating the video image display apparatus in a state where a chassis is incorporated into a joint.

FIG. 5 is a front perspective view illustrating display units.

FIG. 6 is a front perspective view illustrating a state where the chassis is incorporated into the joint, and a rear cover and the display units are assembled thereto.

FIG. 7 is a front perspective view illustrating a control circuit board included in the video image display apparatus according to one or more aspects of the present disclosure.

FIG. 8A is a schematic diagram (front perspective view) illustrating the video image display apparatus including the control circuit board.

FIG. 8B is a schematic diagram (cross-sectional view) illustrating the video image display apparatus including the control circuit board.

FIG. 9 is a schematic diagram illustrating a relationship between optical axes of imaging cameras and positions of display units.

FIG. 10 is a front perspective view illustrating a control circuit board included in a video image display apparatus according to one or more aspects of the present disclosure.

FIG. 11 is a front perspective view illustrating a control circuit board included in a video image display apparatus according to one or more aspects of the present disclosure.

FIG. 12 is a front perspective view illustrating a control circuit board included in a video image display apparatus according to one or more aspects of the present disclosure.

FIG. 13 is a front perspective view illustrating a control circuit board included in a video image display apparatus according to a second exemplary embodiment.

### DESCRIPTION OF THE EMBODIMENTS

Hereinafter, exemplary embodiments of the present disclosure will be described in detail with reference to the drawings.

In the following description, common components are denoted by common reference numerals throughout the drawings. Therefore, common components will be described with reference to the plurality of drawings, and description of components denoted by common reference numerals will be omitted as appropriate.

In the first exemplary embodiment, a video see-through type video image display apparatus 10 (hereinafter, simply referred to as a video image display apparatus 10) is exemplified as the video image display apparatus.

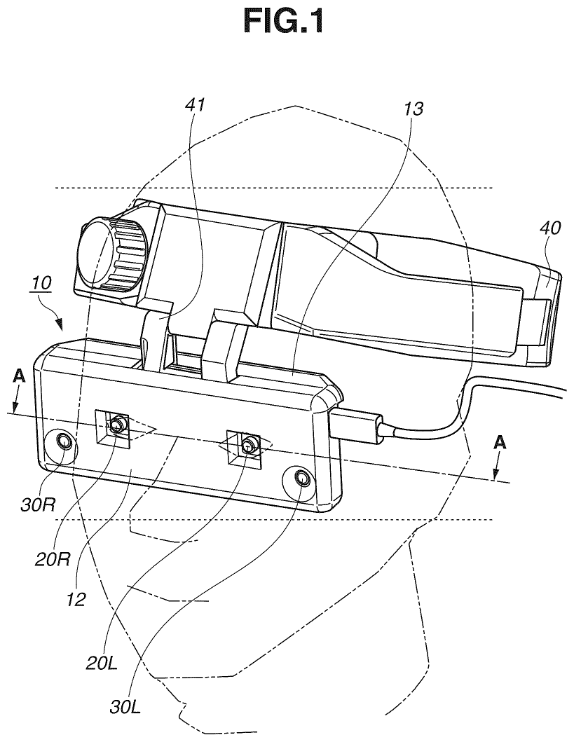

FIG. 1 is a perspective view illustrating a state in which the video image display apparatus 10 according to the present exemplary embodiment is mounted on a head.

A user can observe an image by wearing the video image display apparatus 10 on the head. The video image display apparatus 10 includes a front cover 12 on the front side, a rear cover 13 on the rear side, and imaging cameras 20L and 20R, which are a first imaging unit for the left eye and a second imaging unit for the right eye, and alignment cameras 30L and 30R on the front side. The imaging cameras 20L and 20R are stereo cameras that acquire a surrounding real image. The alignment cameras 30L and 30R are stereo cameras for acquiring the position and the orientation of the video image display apparatus 10 from the acquired image by using feature points, such as a marker and an edge, of an object.

In the present exemplary embodiment, the imaging cameras 20L and 20R and the alignment cameras 30L and 30R are separately provided. The alignment cameras 30L and 30R, which use monochrome images, make alignment with high accuracy and high fault tolerance by using a wide view angle, a high shutter speed, a long baseline length, and the like. It is also possible to perform both acquisition of a display image and acquisition of alignment information only by the imaging cameras 20L and 20R without using the alignment cameras 30L and 30R. It is also possible to replace the alignment cameras 30L and 30R with a range sensor or the like that uses ultrasonic waves, infrared rays, or the like. The video image display apparatus 10 is connected to a head mounted tool 40, and the video image display apparatus 10 can be rotated around a rotation axis 41 formed in the head mounted tool 40. A display can be opposed to the face during observation as illustrated in FIG. 1, and can be flipped up during non-observation.

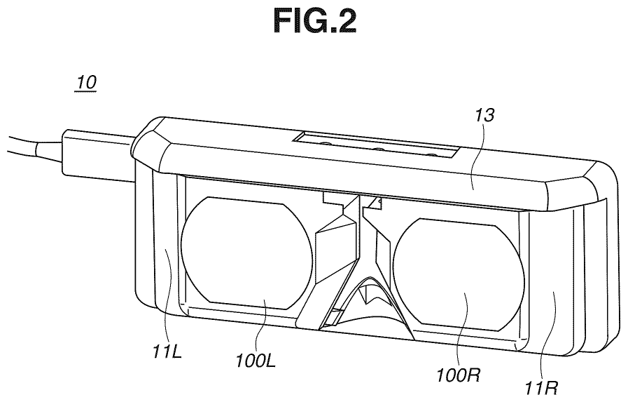

FIG. 2 is a perspective view of the video image display apparatus 10 according to the present exemplary embodiment as viewed from the rear side.

The video image display apparatus 10 includes a display unit 100L for the left eye and a display unit 100R for the right eye as a first display unit for the left eye and a second display unit for the right eye on the back side, and the user observes a video image by looking into the display units 100L and 100R. Hoods 11L and 11R are provided around the display units 100L and 100R, and right-and-left positions of the display units 100L and 100R can be adjusted to match an interpupillary distance of the user.

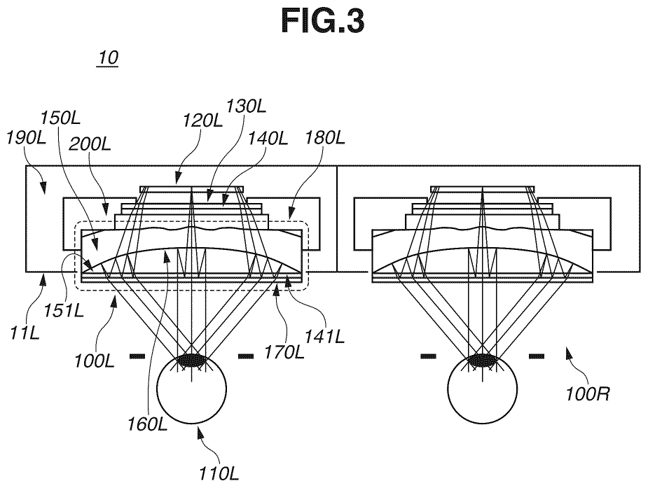

FIG. 3 is a cross-sectional view along a dashed line A-A in FIG. 1.

The configuration of the left and right display units 100L and 100R will be described with reference to FIG. 3. In FIG. 3, components unnecessary for the description are omitted. The display unit 100L for the left eye and the display unit 100R for the right eye have the same configuration, so that the reference numerals for the right eye side are not illustrated, and description will be given of the left eye as an example.

The display unit 100L enlarges and projects an original image displayed on a display element 120L as a virtual image and guides the virtual image to an eye 110L of the user. The display unit 100L includes an optical system that folds an optical path by using polarized light, and the optical path will be described.

First, as illustrated in FIG. 3, a polarizing plate 130L and a first phase plate 140L are disposed between the display element 120L and a lens 150L in this order from a display element 120L side, and a half mirror 160L is formed by vapor deposition on a surface on a lens 151L side of the lens 150L. The vapor deposited surface of the half mirror 160L acts as a semi-transmissive reflection surface. In the present exemplary embodiment, the polarizing plate 130L and the first phase plate 140L are integrated and fixed to a lens barrel 200L. Next, a second phase plate 141L and a polarizing beam splitter (PBS) 170L as a polarization beam splitter element are disposed in this order from the display element 120L side between the lens 151L and the eye 110L of the user. The second phase plate 141L and the PBS 170L are planar. The first phase plate 140L and the second phase plate 141L are waveplates with a phase difference of λ/4. The second phase plate 141L is held in contact with the lens 151L. In the present exemplary embodiment, the second phase plate 141L and the PBS 170L are integrated and attached onto the lens 150L. The lenses 150L and 151L are cemented together to form a lens unit 180L together with the second phase plate 141L and the PBS 170L. The lens unit 180L is fixed to the lens barrel 200L.

At this time, a polarizing direction in which the polarizing plate 130L transmits light and a retardation axis of the first phase plate 140L are inclined at 45 degrees, and a polarizing direction in which the PBS 170L transmits light and a retardation axis of the second phase plates 141L are inclined at 45 degrees. The polarizing direction in which the polarizing plate 130L transmits light and the polarizing direction in which the PBS 170L transmits light are orthogonal to each other.

In such a configuration, light emitted from the display element 120L is transmitted through the polarizing plate 130L to become linearly polarized light and is transmitted through the first phase plate 140L to become circularly polarized light. The light is transmitted through the half mirror 160L and the second phase plate 141L to become linearly polarized light (first linearly polarized light). Since the polarizing direction of the linearly polarized light is orthogonal to the polarizing direction of the light transmitted through the PBS 170L, the light is reflected on the PBS 170L and transmitted through the second phase plate 141L to become circularly polarized light. The light is reflected on the half mirror 160L and transmitted through the second phase plate 141L to become linearly polarized light (second linearly polarized light), but the polarizing direction of the linearly polarized light is different from that in the previous case, and coincides with the polarizing direction of the light transmitting through the PBS 170L, and therefore the light having transmitted through the PBS 170L is guided to the eye 110L of the user. The eye 110L of the user coincides with an exit pupil of the display unit 100L. By using the optical system that folds the optical path by using polarized light in this way, it is possible to achieve a thin design, a short focal length, and image observation with a wide angle of view.

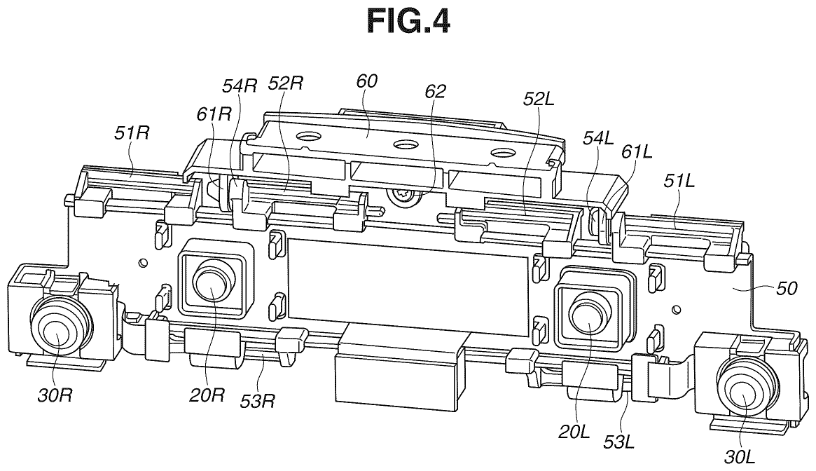

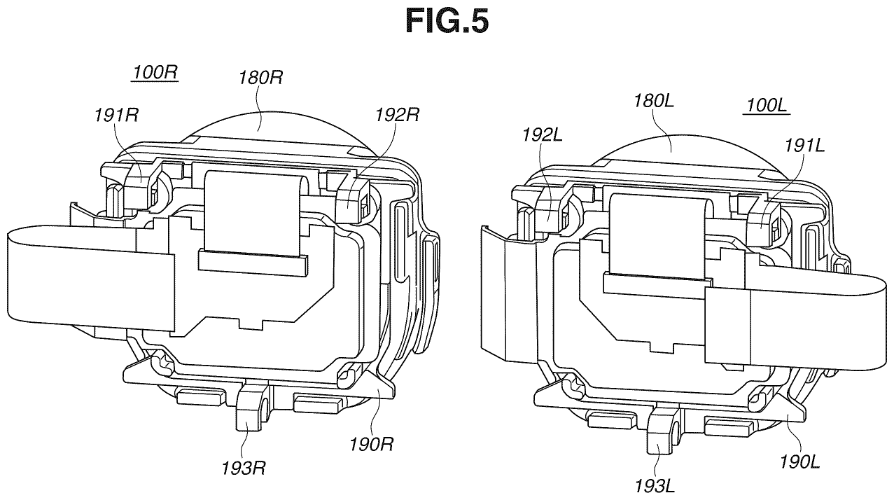

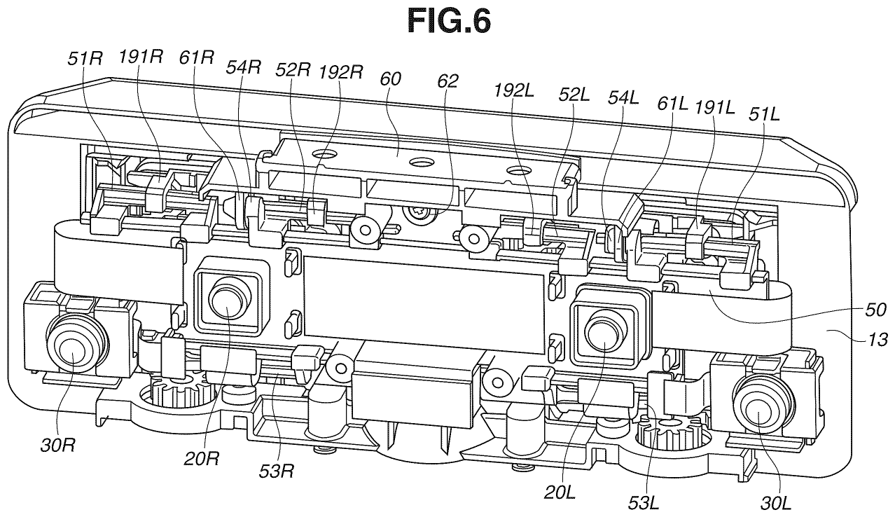

Hereinafter, a configuration of the video image display apparatus 10 will be described with reference to FIGS. 4 to 6. FIG. 4 is a front perspective view illustrating the video image display apparatus 10 in a state where a chassis 50 is incorporated into a joint 60. FIG. 5 is a front perspective view illustrating the display units 100L and 100R. FIG. 6 is a front perspective view illustrating a state where the chassis 50 is incorporated into the joint 60, and the rear cover 13 and the display units 100L and 100R are mounted thereto.

As illustrated in FIG. 4, the imaging cameras 20L and 20R and the alignment cameras 30L and 30R are adhesively fixed to the chassis 50. At this time, an inclination and a rotation direction are adjusted so that optical axes of the imaging cameras 20L and 20R and the alignment cameras 30L and 30R coincide with each other, and then the imaging cameras 20L and 20R and the alignment cameras 30L and 30R are fixed. The chassis 50 is made of a metal material, not a resin, in order to minimize thermal expansion and thermal contraction. The chassis 50 is a component integrally molded with a resin portion, and includes arm portions 51L and 51R, 52L, 52R, 53L, and 53R, and bosses 54L and 54R. The bosses 54L and 54R are fitted into holes 61L and 61R formed in the joint 60, and the chassis 50 is held so as to be rotatable (turnable) with respect to the joint 60 with the bosses 54L and 54R as the center of rotation. The joint 60 is fixed to the rear cover 13 with a screw 62.

As illustrated in FIG. 5, lens barrels 190L and 190R have grooves 191L, 191R, 192L, 192R, 193L, and 193R.

As illustrated in FIG. 6, the grooves 191L, 191R, 192L, 192R, 193L, and 193R are fitted into the arm portions 51L, 51R, 52L, 52R, 53L, and 53R provided on the chassis 50, and are held so as to be movable in right-and-left directions.

As described above, the chassis 50 and the display units 100L and 100R are fixed to the rear cover 13 via the joint 60. Finally, the front cover 12 is added to the rear cover 13 so that the position of the chassis 50 in a front-rear direction is determined.

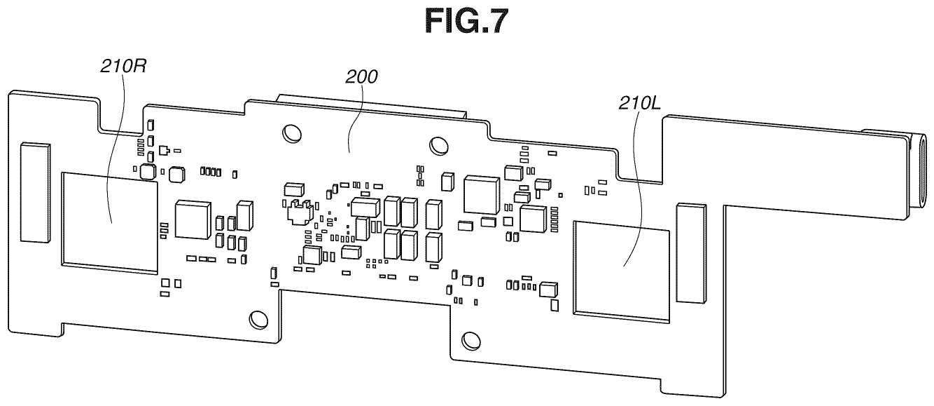

FIG. 7 is a front perspective view illustrating a control circuit board included in the video image display apparatus 10 according to the present exemplary embodiment.

A control circuit board 200 is a board including various electronic circuits for controlling the imaging cameras 20L and 20R, the alignment cameras 30L and 30R, and the display units 100L and 100R. In the present exemplary embodiment, openings 210L and 210R serving as a first exposed area and a second exposed area that expose at least portions of the imaging cameras 20L and 20R (portions of optical members of the imaging cameras 20L and 20R) are formed in the control circuit board 200.

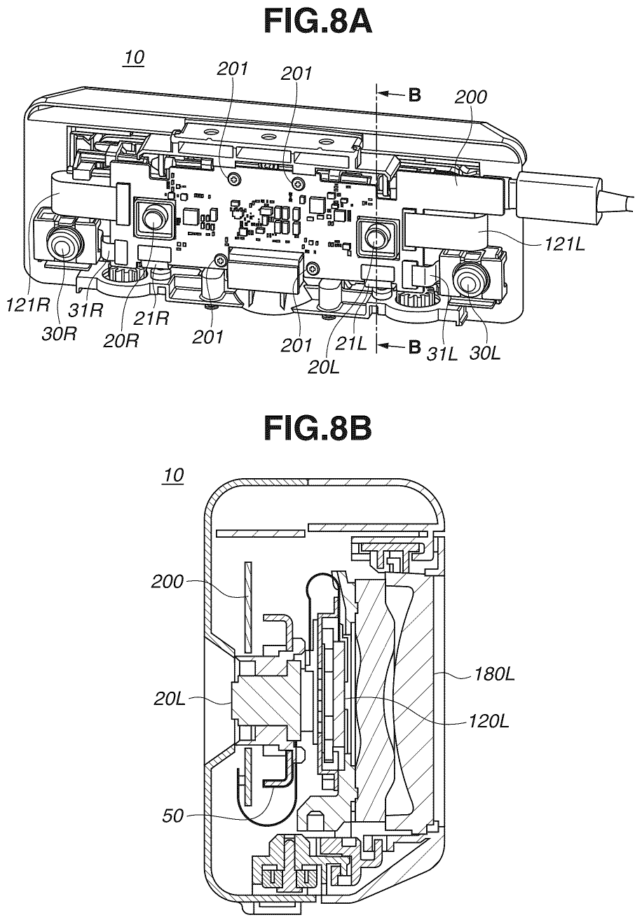

FIGS. 8A and 8B are schematic diagrams illustrating the video image display apparatus 10 including the control circuit board 200. FIG. 8A is a front perspective view of the video image display apparatus 10 with the front cover 12 removed, and FIG. 8B is a cross-sectional view along a broken line B-B in FIG. 8A.

The control circuit board 200 is electrically connected to wiring lines 21L, 21R, 31L, 31R, 121L, and 121R from the imaging cameras 20L and 20R, the alignment cameras 30L and 30R, and the display elements 120L and 120R, respectively. The control circuit board 200 is fixed to the rear cover 13 with, for example, four screws 201. At this time, the imaging cameras 20L and 20R are aligned with the openings 210L and 210R provided in the control circuit board 200, and the imaging cameras 20L and 20R are exposed from the openings 210L and 210R, respectively. In the present exemplary embodiment, the imaging cameras 20L and 20R are in an independent state of not being constrained to each other in relation to the control circuit board 200, i.e., in a non-contact state of being separated from edge portions of the openings 210L and 210R of the control circuit board 200.

As illustrated in FIG. 8B, the control circuit board 200 is located in front of the chassis 50, which is a holding member that holds the imaging cameras 20L and 20R and the alignment cameras 30L and 30R. The imaging cameras 20L and 20R partially overlap the control circuit board 200 in a side view, and the control circuit board 200 is located behind front edges of the imaging cameras 20L and 20R.

In the present exemplary embodiment, in the video image display apparatus 10, the control circuit board 200 in which the openings 210L and 210R, which expose at least portions of the imaging cameras 20L and 20R, are formed is disposed at the above-described position in relation to the chassis 50 and the imaging cameras 20L and 20R. With this configuration, it is possible to miniaturize the apparatus without an increase in thickness of the apparatus due to arrangement of the control circuit board 200. Further, a space for accommodating the control circuit board 200 is not required between the imaging cameras 20L and 20R and the display units 100L and 100R. Therefore, it is possible to prevent an increase in positional shift between the imaging cameras 20L and 20R and the display units 100L and 100R, respectively, and to reduce a difference in display magnification from reality.

In the present exemplary embodiment, in the video image display apparatus 10, the imaging cameras 20L and 20R are exposed from the openings 210L and 210R of the control circuit board 200, and are in a non-contact state of being separated from the edge portions of the openings 210L and 210R of the control circuit board 200. With this configuration, the optical axes of the imaging cameras 20L and 20R are not affected by an inclination of the control circuit board 200. Therefore, by matching an optical axis direction of the imaging camera 20L and an optical axis direction of the imaging camera 20R with each other, it is possible to prevent misalignment of the optical axes due to a relationship with the control circuit board 200 from occurring between the imaging camera 20L and the imaging camera 20R.

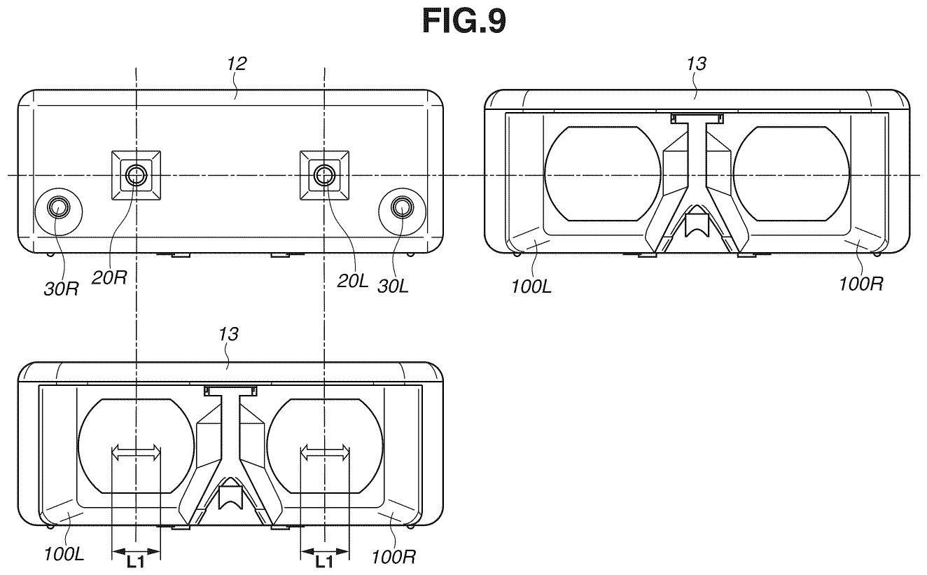

FIG. 9 is a schematic diagram illustrating a relationship between the optical axes of the imaging cameras 20L and 20R and positions of the display units 100L and 100R.

The display units 100L and 100R are configured such that the horizontal positions thereof can be adjusted in accordance with a distance between the eyes of the user, and an adjustable range L1 is illustrated in FIG. 9. The imaging cameras 20L and 20R are in a non-contact state of being separated from the edge portions of the openings 210L and 210R of the control circuit board 200, and the optical axes of the imaging cameras 20L and 20R are not affected by the inclination of the control circuit board 200. Therefore, as illustrated in FIG. 9, the vertical position of the optical axis of each of the imaging cameras 20L and 20R is matched with the vertical display center of each of the display units 100L and 100R, and the horizontal position of the optical axis can be set to fall within the adjustable range L1 of each of the display units 100L and 100R. As described above, in the present exemplary embodiment, in the video image display apparatus 10, it is possible to minimize the misalignment of the optical axis with respect to the display center of the display unit 100L of the imaging camera 20L and the misalignment of the optical axis with respect to the display center of the display unit 100R of the imaging camera 20R.

In the present exemplary embodiment, the case where the imaging cameras 20L and 20R partially overlap the control circuit board 200 in the side view of the video image display apparatus 10 has been exemplified. In this case, when the imaging cameras 20L and 20R are particularly thin, it may be difficult to overlap the imaging cameras 20L and 20R with the control circuit board 200 in the side view. In such a case, overlapping is not necessarily required. It is only necessary to, for example, dispose the control circuit board 200 in front of the imaging cameras 20L and 20R and expose the imaging cameras 20L and 20R through the openings 210L and 210R provided in the control circuit board 200, so that a desired image can be acquired without the captured image being partially lost due to the control circuit board 200.

In this case as well, the misalignment of the optical axes does not occur in the imaging cameras 20L and 20R due to the relationship with the control circuit board 200. With the control circuit board 200, it is possible to miniaturize the apparatus without an increase in thickness of the apparatus. It is also possible to prevent an increase in positional shift between the imaging cameras 20L and 20R and the display units 100L and 100R, respectively, and to reduce a difference in display magnification from the reality.

In the present exemplary embodiment, the case where the left and right positions of the display units 100L and 100R can be adjusted in accordance with the interpupillary distance of the user has been exemplified. However, an adjustment thereof is not always necessary. In such a case, the optical axis of the imaging camera 20L and the display center of the display unit 100L are matched, and the optical axis of the imaging camera 20R and the display center of the display unit 100R are matched, and thus it is possible to acquire an image without the misalignment of the optical axes.

Now, various modifications of the present exemplary embodiment will be described.

### [First Modification]

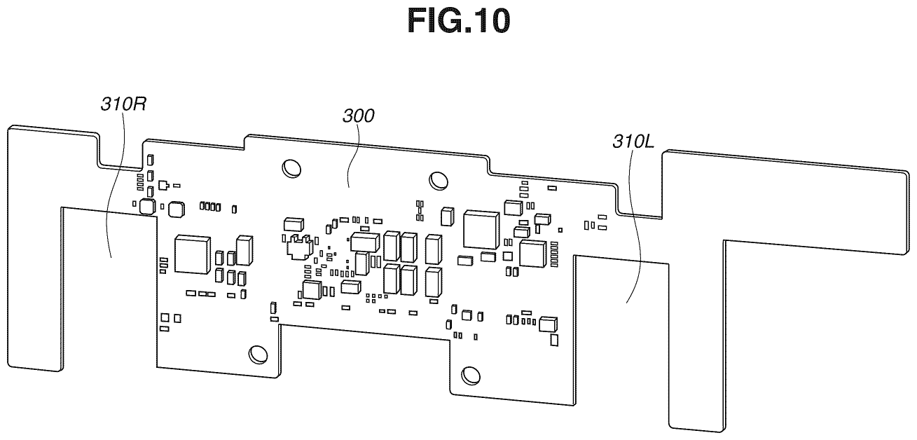

FIG. 10 is a front perspective view illustrating a control circuit board included in a video image display apparatus 10 according to a first modification of the first exemplary embodiment.

A control circuit board 300 is a board including various circuits for controlling the imaging cameras 20L and 20R, the alignment cameras 30L and 30R, and the display units 100L and 100R, similar to the control circuit board 200 described in the first exemplary embodiment. In the first modification, the control circuit board 300 has cutouts 310L and 310R serving as a first exposed area and a second exposed area for exposing at least portions of the imaging cameras 20L and 20R, instead of the openings 210L and 210R of the control circuit board 200. The first exposed area and the second exposed area do not necessarily have to be openings each in a shape surrounded by an edge portion of four sides as in the present exemplary embodiment, and may be, for example, cutouts 310L and 310R each having an edge portion with three sides remaining and a lower side being removed as illustrated in FIG. 10.

The control circuit board 300 is electrically connected to the wiring lines 21L, 21R, 31L, 31R, 121L, and 121R from the imaging cameras 20L and 20R, the alignment cameras 30L and 30R, and the display elements 120L and 120R, respectively. The control circuit board 300 is fixed to the rear cover 13 with, for example, the four screws 201. At this time, the imaging cameras 20L and 20R are in an independent state of not being constrained to each other via the control circuit board 300, i.e., in a non-contact state of being separated from the control circuit board 300, and the imaging cameras 20L and 20R are exposed from the cutouts 310L and 310R provided in the control circuit board 300.

According to the first modification, it is possible to prevent the misalignment of the optical axes from occurring between the imaging camera 20L and the imaging camera 20R due to the relationship with the control circuit board 300. With the control circuit board 300, it is possible to miniaturize the apparatus without an increase in thickness of the apparatus. It is also possible to prevent an increase in positional shift between the imaging cameras 20L and 20R and the display units 100L and 100R, respectively, and to reduce a difference in display magnification from the reality.

### [Second Modification]

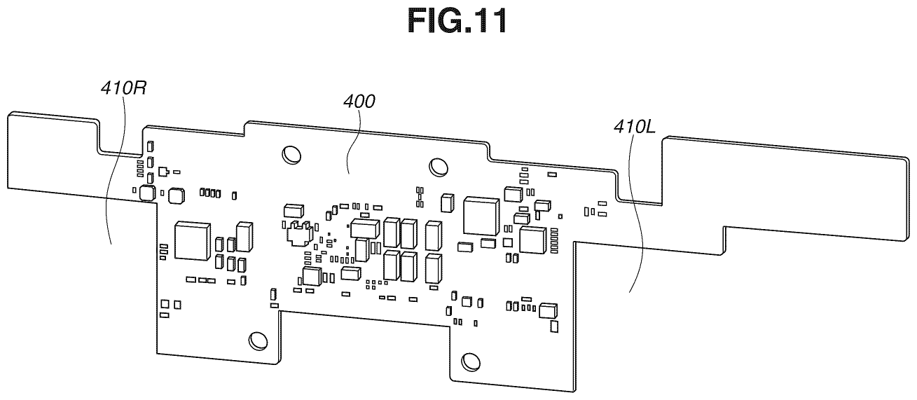

FIG. 11 is a front perspective view illustrating a control circuit board included in a video image display apparatus 10 according to a second modification of the first exemplary embodiment.

A control circuit board 400 is a board including various circuits for controlling the imaging cameras 20L and 20R, the alignment cameras 30L and 30R, and the display units 100L and 100R, similar to the control circuit board 200 described in the first exemplary embodiment. In the second modification, the control circuit board 400 has cutouts 410L and 410R serving as a first exposed area and a second exposed area for exposing at least portions of the imaging cameras 20L and 20R, instead of the openings 210L and 210R of the control circuit board 200. The first exposed area and the second exposed area do not necessarily have to be the openings each in the shape surrounded by the edge portion of four sides as in the present exemplary embodiment, and may be, for example, cutouts 410L and 410R each having an edge portion with two sides remaining and a lower side and a lateral side being removed as illustrated in FIG. 11.

The control circuit board 400 is electrically connected to the wiring lines 21L, 21R, 31L, 31R, 121L, and 121R from the imaging cameras 20L and 20R, the alignment cameras 30L and 30R, and the display elements 120L and 120R, respectively. The control circuit board 400 is fixed to the rear cover 13 with, for example, the four screws 201. At this time, the imaging cameras 20L and 20R are in an independent state of not being constrained to each other via the control circuit board 400, i.e., in a non-contact state of being separated from the control circuit board 400, and the imaging cameras 20L and 20R are exposed from the cutouts 410L and 410R provided in the control circuit board 400.

According to the second modification, it is possible to prevent the misalignment of the optical axes from occurring between the imaging camera 20L and the imaging camera 20R due to the relationship with the control circuit board 400. With the control circuit board 400, it is possible to miniaturize the apparatus without an increase in thickness of the apparatus. It is also possible to prevent an increase in positional shift between the imaging cameras 20L and 20R and the display units 100L and 100R, respectively, and to reduce a difference in display magnification from the reality.

### [Third Modification]

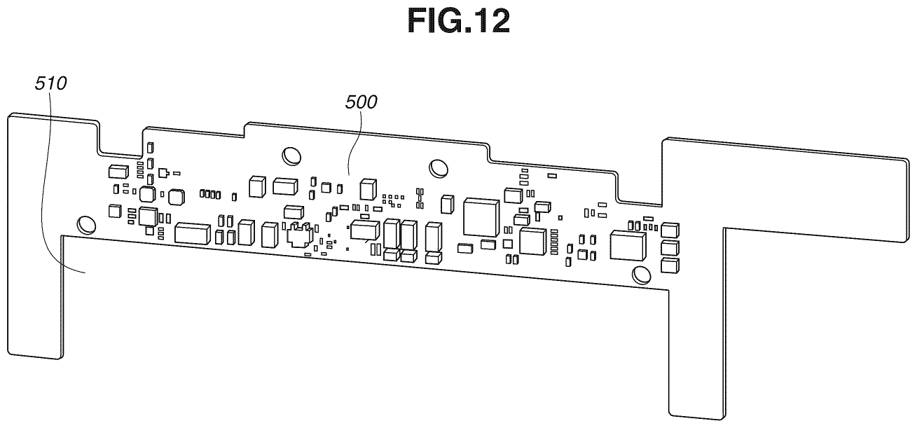

FIG. 12 is a front perspective view illustrating a control circuit board included in a video image display apparatus 10 according to a third modification of the first exemplary embodiment.

A control circuit board 500 is a board including various circuits for controlling the imaging cameras 20L and 20R, the alignment cameras 30L and 30R, and the display units 100L and 100R, similar to the control circuit board 200 described in the first exemplary embodiment. In the third modification, the control circuit board 500 has a cutout 510 serving as an integral exposed area that exposes at least portions of the imaging cameras 20L and 20R (portions of the optical members of the imaging cameras 20L and 20R) instead of the openings 210L and 210R of the control circuit board 200. The exposed area of the control circuit board 500 does not necessarily have to be two openings each in the shape surrounded by the edge portion of four sides as in the present exemplary embodiment, and may be, for example, one cutout 510 having an edge portion with three sides remaining and a lower side being removed as illustrated in FIG. 12.

The control circuit board 500 is electrically connected to the wiring lines 21L, 21R, 31L, 31R, 121L, and 121R from the imaging cameras 20L and 20R, the alignment cameras 30L and 30R, and the display elements 120L and 120R, respectively. The control circuit board 500 is fixed to the rear cover 13 with, for example, the four screws 201. At this time, the imaging cameras 20L and 20R are in an independent state of not being constrained to each other via the control circuit board 500, i.e., in a non-contact state of being separated from the control circuit board 500, and the imaging cameras 20L and 20R are exposed from the cutout 510 provided in the control circuit board 500.

According to the third modification, it is possible to prevent the misalignment of the optical axes from occurring between the imaging camera 20L and imaging camera 20R due to the relationship with the control circuit board 500. With the control circuit board 500, it is possible to miniaturize the apparatus without an increase in thickness of the apparatus. It is also possible to prevent an increase in positional shift between the imaging cameras 20L and 20R and the display units 100L and 100R, respectively, and to reduce a difference in display magnification from the reality.

Note that the present disclosure is not limited to the present exemplary embodiment and the above-described first to third modifications, and the shape of the opening(s) or the cutout(s) provided in the control circuit board is not limited. The present disclosure can be applied as long as an area(s) from which the imaging cameras 20L and 20R are exposed is/are formed in the control circuit board.

In a second exemplary embodiment, a video see-through type video image display apparatus 10 is discussed as in the first exemplary embodiment, but the second exemplary embodiment is different from the first exemplary embodiment in that an installation state of the imaging cameras and the control circuit board are different. In the present exemplary embodiment, the same parts as those in the first exemplary embodiment will not be described, and the same reference numerals as those in the first exemplary embodiment will be used.

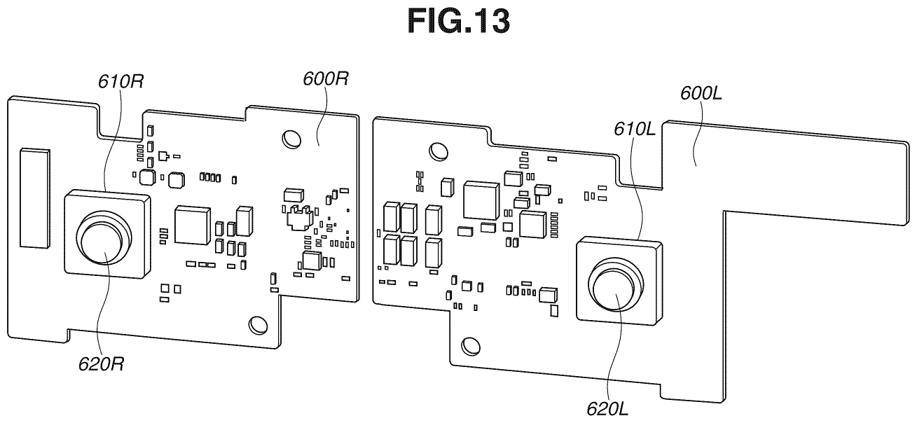

FIG. 13 is a front perspective view illustrating a control circuit board included in a video image display apparatus 10 according to the present exemplary embodiment.

In the present exemplary embodiment, the control circuit board is divided into two, left and right, control circuit boards, i.e., a control circuit board 600L which is a first control circuit board and a control circuit board 600R which is a second control circuit board. An opening 610L is formed in the control circuit board 600L, and an opening 610R is formed in the control circuit board 600R. An imaging camera 620L for the left eye is mounted and fixed on the control circuit board 600L so that a front surface portion thereof is exposed from the opening 610L. An imaging camera 620R for the right eye is mounted and fixed on the control circuit board 600R so that a front surface portion thereof is exposed from the opening 610R. The control circuit boards 600L and 600R are electrically connected to each other with a wiring board (not illustrated).

In the present exemplary embodiment, the imaging cameras 620L and 620R are fixed to the control circuit boards 600L and 600R, respectively, and the control circuit boards 600L and 600R are separate from each other. Therefore, the imaging cameras 620L and 620R are in an independent state of not being constrained to each other in relation to the control circuit boards 600L and 600R. In other words, the imaging camera 620L fixed to the control circuit board 600L and the imaging camera 620R fixed to the control circuit board 600R are independent of each other.

Therefore, the imaging camera 620L is not affected by the control circuit board 600R, and the imaging camera 620R is not affected by the control circuit board 600L. Therefore, by matching an optical axis direction of the imaging camera 620L and an optical axis direction of the imaging camera 620R with each other, it is possible to prevent misalignment of the optical axes due to a relationship with the control circuit boards 600L and 600R from occurring between the imaging camera 620L and the imaging camera 620R.

In the present exemplary embodiment, since the imaging cameras 620L and 620R are in the mutually independent state as described above, the imaging cameras 620L and 620R are adjusted such that the positions of the optical axes match the display centers of the display units 100L and 100R, respectively. Here, positions in horizontal directions intersecting with the optical axes as the centers may be adjusted to fall within adjustable ranges of the display units 100L and 100R.

If the control circuit boards 600L and 600R are fixed to the rear cover 13 in a state where the optical axes are not aligned, the optical axis directions of the imaging cameras 620L and 620R do not match with each other due to influence of mounting deviation of the imaging cameras 620L and 620R and influence of warpage of the rear cover 13. In order to prevent these, the control circuit boards 600L and 600R are fixed to the rear cover 13 after, for example, the inclination and the rotation direction of the control circuit boards 600L and 600R are adjusted so that the optical axis directions of the imaging cameras 620L and 620R match with each other as described above. As described above, the state where the optical axis directions of the imaging cameras 620L and 620R match with each other can be maintained. In the present exemplary embodiment, the control circuit board is divided into two, the control circuit board 600L and the control circuit board 600R, so that the optical axis directions of the left and right imaging cameras 620L and 620R can be matched.

According to the present exemplary embodiment, the misalignment of the optical axes does not occur in the imaging cameras 620L and 620R due to the relationship with the control circuit boards 600L and 600R. With the control circuit boards 600L and 600R, it is possible to miniaturize the apparatus without an increase in thickness of the apparatus. It is also possible to prevent an increase in positional shift between the imaging cameras 620L and 620R and the display units 100L and 100R, respectively, and to reduce a difference in display magnification from the reality.

In the present exemplary embodiment, since the imaging cameras 620L and 620R are respectively fixed to the control circuit boards 600L and 600R each on the front end side thereof, the rear end side of each of the imaging cameras 620L and 620R may be in a non-fixed state. In this case, the chassis 50 for holding and fixing the imaging cameras may not be provided. The alignment cameras 30L and 30R are fixed to another member, for example, the rear cover 13. By omitting the chassis 50, distances between the control circuit boards 600L and 600R and the display units 100L and 100R, respectively, can be reduced. This makes it possible to further reduce the size of the apparatus and prevent an increase in positional shift between the imaging cameras 620L and 620R and the display units 100L and 100R, respectively, and to reduce a difference in display magnification from the reality.

In the present exemplary embodiment, the case where the control circuit board is divided at substantially the center into the left and right control circuit boards 600L and 600R having substantially the same sizes has been exemplified, but the present disclosure is not limited thereto, and the sizes may be different. For example, one of the control circuit boards 600L and 600R may be increased in size as much as possible to concentrate a large amount of electronic circuitry for performing main functions on this control circuit board, and the other control circuit board may be limited to a minimum amount of electronic circuitry required for controlling the imaging cameras. By configuring the control circuit boards 600L and 600R in this way, the wiring lines to be connected to the control circuit boards can be arranged around the large control circuit board in a concentrated manner, which leads to reducing wiring distances and contributing to the miniaturization of the apparatus.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-100854, filed Jun. 20, 2023, which is hereby incorporated by reference herein in its entirety.

What is claimed is:

1. A video image display apparatus comprising:
a first imaging unit corresponding to a left eye of a user;
a second imaging unit corresponding to a right eye of the user;
a first display unit configured to display an image captured by the first imaging unit;
a second display unit configured to display an image captured by the second imaging unit; and
a control unit configured to control the first imaging unit and the second imaging unit,
wherein the control unit is provided with an exposed area, and
wherein the first imaging unit and the second imaging unit are in an independent state of not being constrained to each other in relation to the control unit, and at least portions thereof are exposed from the exposed area.

2. The video image display apparatus according to claim 1, wherein the exposed area includes a first exposed area where at least the portion of the first imaging unit is exposed, and a second exposed area where at least the portion of the second imaging unit is exposed.

3. The video image display apparatus according to claim 1, wherein the exposed area is an integral area that exposes at least the portions of both the first imaging unit and the second imaging unit.

4. The video image display apparatus according to claim 1, wherein the exposed area is each an opening formed in the control unit.

5. The video image display apparatus according to claim 1, wherein the exposed area is each a cutout formed in the control unit.

6. The video image display apparatus according to claim 1, wherein the first imaging unit and the second imaging unit are separated from the control unit.

7. The video image display apparatus according to claim 2,
wherein the control unit includes a first control unit and a second control unit which are separated from each other,
wherein the first imaging unit is at least partially exposed from the first exposed area and is fixed to the first control unit, and
wherein the second imaging unit is at least partially exposed from the second exposed area and is fixed to the second control unit.

8. The video image display apparatus according to claim 7, wherein the first imaging unit and the second imaging unit are in a non-fixed state on a rear end side.

9. The video image display apparatus according to claim 7, wherein the first control unit and the second control unit are different in size, and a mounting amount of electronic circuitry in a larger control unit being one of the first control unit and the second control unit is larger than a mounting amount of electronic circuitry in a smaller control unit being the other of the first control unit and the second control unit.

10. The video image display apparatus according to claim 1, wherein at least the portions of the first imaging unit and the second imaging unit overlap the control unit in a side view.

11. The video image display apparatus according to claim 1,
wherein a position of an optical axis of the first imaging unit matches a display center of the first display unit, and
wherein a position of an optical axis of the second imaging unit matches a display center of the second display unit.

12. The video image display apparatus according to claim 1,
wherein horizontal positions of the first display unit and the second display unit are adjustable in accordance with a distance between both eyes of a user, and
wherein positions of optical axes of the first imaging unit and the second imaging unit are within an adjustable range of the horizontal positions of the first display unit and the second display unit.

13. The video image display apparatus according to claim 1, further comprising a holding member operable to hold the first imaging unit and the second imaging unit,
wherein the control unit is located in front of the holding member and located behind front edges of the first imaging unit and the second imaging unit.
